(19) United States
(12) Patent Application Publication
(10) Pub. No.: US 2002/0083374 A1
(43) Pub. Date: Jun. 27, 2002

(54) Identification module for a passive component of a system

(75) Inventors: Mark R. Hinds, Ottawa (CA); Francois Boudreault, Ottawa (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/746,199

(22) Filed: Dec. 26, 2000

(51) Int. Cl. H04L 1/22

(52) U.S. Cl. 714/47

(57) ABSTRACT

An identification module for one or more passive components in a system is used for storing information relating to the passive components. By storing component information relating to a passive component in a non-volatile memory module, such as a serial electrically erasable programmable read-only memory module, and incorporating the module into a sub-system having the passive component, the component information may be obtained at any time. This can reduce the time required to identify specifications of, and verify operation of, the passive components of a system. The probability of human error may also be reduced.

### FIELD OF THE INVENTION

The present invention relates to an identification module for a passive component and to a sub-system having at least one passive component and an identification module.

### BACKGROUND OF THE INVENTION

In electrical, transmission and communication systems, proper operation of the system is dependent upon the proper components being installed in the system and the proper operation of these components. Components may be active or passive. A passive component is any component which does not require a source of energy for its operation. Examples of these include electrical filters, power combiners, power splitters, mixers, other passive RF components, passive optical devices such as optical filter modules, optical power splitters and combiners, and other optical modules such as optical fiber dispersion compensation modules (DCMs) or dispersion and dispersion slope compensation modules (DSCMs).

Ensuring selection of a proper component during system installation can be made more difficult where components with very different operating characteristics are physically similar. Presently, a system line-up and test (SLAT) is performed in an effort to avoid incorrect passive component installation. A SLAT has a set of detailed instructions outlining how to install a passive component within a system. The SLAT includes testing instructions by which the installer can manually verify that the correct passive component has been installed. The manual tests involve inputting known or measured signals to the passive component and confirming the output signal conforms to the desired (predetermined) characteristics by using the same measurement technique as on the input. If the predetermined characteristics are not achieved, the installer must conclude that an incorrect or damaged passive component has been installed and therefore the component must be replaced.

When installing passive components in systems, an inventory database, or log, of installed passive components may be kept to track the various passive components and their locations within the system. This is quite useful when a passive component breaks down or its performance degrades and the component requires replacement. By having the inventory, once the bad component is located, a simple reference to the inventory database, or log, reveals what replacement passive component is required. However, all of this inventory information must be manually entered into the inventory database, or log. This can be quite time consuming if there are many passive components in the system.

Therefore, it would be advantageous to be able to simply verify the specifications of passive components in a system on installation and afterwards on an “as needed” basis. It might also be useful to be able to periodically check the actual performance of a passive component.

### SUMMARY OF THE INVENTION

The present invention provides an identification module for one or more passive components in a system. The identification module is used for storing information relating to the passive components. By storing component information relating to a passive component in a non-volatile memory module, such as a serial electrically erasable programmable read-only memory module, and incorporating the module into a sub-system having the passive component, the component information may be obtained at any time. This can reduce the time required to identify specifications of, and verify operation of, the passive components of a system. The probability of human error may also be reduced.

The component information may include, but is not limited to, component identification information, component specifications, and component calibration data. it will be understood that the present invention is particularly advantageous in respect of the identification of passive components which are quite costly such as dispersion compensation modules (DCMs).

According to an aspect of the present invention, there is provided a sub-system including at least one passive component; and an identification module for storing component information relating to the at least one passive component.

According to another aspect of the present invention, there is provided apparatus for monitoring a passive component, comprising: a non-volatile memory storing specifications for a passive component; a tester for detecting signals at an input and output of said passive component; and a processor operatively associated with said non-volatile memory and said tester for monitoring proper performance of said passive component.

According to a further aspect of the invention, there is provided a method for facilitating monitoring of a passive component, comprising: storing component information for said passive component in a non-volatile memory; and installing said non-volatile memory in a sub-system incorporating said passive component.

According to a yet further aspect of the invention, there is provided a method for monitoring a passive component, comprising: retrieving specification information for said passive component from non-volatile memory installed in a sub-system incorporating said passive component; sampling an input signal to and an output signal from said passive component; determining performance characteristics for said passive component based on said sampling; comparing said performance characteristics with said retrieved specification information.

Other aspects and features of the present invention will become apparent to those ordinarily skilled in the art upon review of the following description of a specific embodiment of the invention in conjunction with the accompanying figures.

### BRIEF DESCRIPTION OF THE DRAWINGS

In the following figures which illustrate, by example only, embodiments of the invention:

FIG. 1 is a schematic diagram of a sub-system including an identification module exemplary of an embodiment of the present invention;

FIG. 2 is a detail schematic diagram of the identification module of FIG. 1 shown interfaced with a processor and a tester; and

FIG. 3 is a system made in accordance with this invention.

### DETAILED DESCRIPTION

The present invention is concerned with a system which includes at least one passive component. An identification module has a non-volatile memory for storing component information relating to the identification of, and specifications and calibration data for, the passive component. The identification module may also have a second memory to store information relating to the performance of the passive component in actual operation.

Although primarily concerned with more expensive passive components such as a dispersion compensation module or an antenna subsystem, it will be understood that the present invention may also be applicable to less expensive passive components.

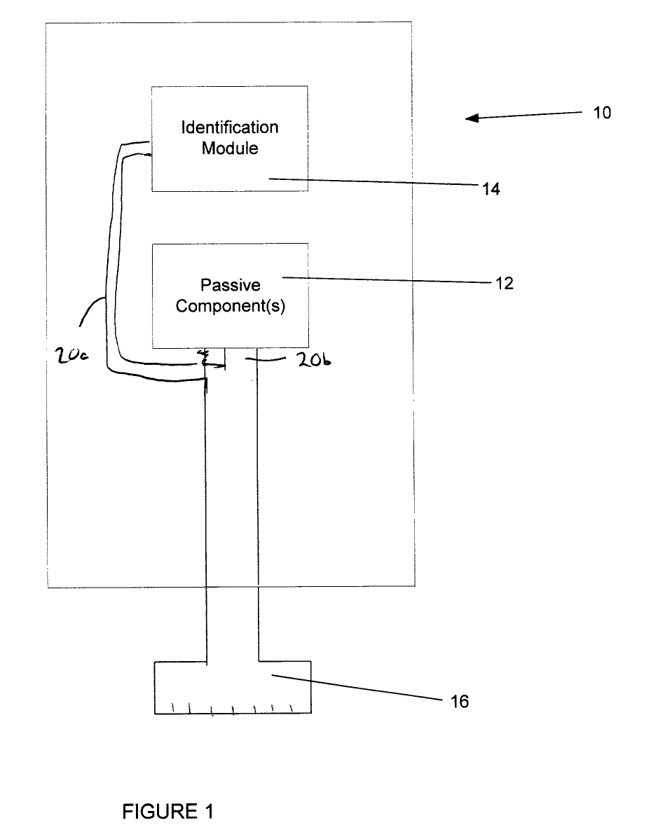

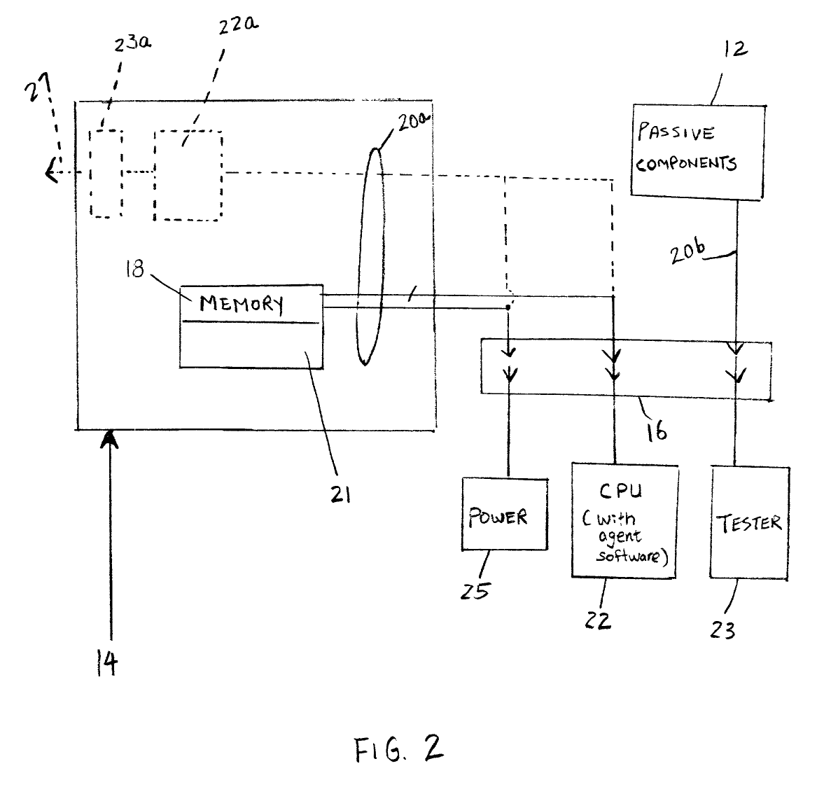

FIG. 1 shows a sub-system 10 which includes at least one passive component 12 and an identification module 14, exemplary of an embodiment of the present invention. The identification module 14 is used for storing component information relating to the identification of, and specifications and calibration data for, the passive component(s) and may also store historical information corresponding to the performance of the passive component in operation. The sub-system 10 further includes paths 20a from identification module 14 and paths 20b from the passive components 12 to interface 16 for connecting the sub-system 10 with other parts of a system. The interface 16 provides terminals for the passive components (which may be arranged as a passive component circuit). These terminals may be either optical, mechanical or electrical terminals depending on the nature of the passive components 12. As illustrated in FIG. 2, the identification module 14 comprises a non-volatile memory module 18, in the form of an electrically erasable programmable read-only memory (EEPROM). The memory 18 stores static information (e.g., identification information and specifications) for the passive components such as, component model number, component manufacturer ID, component serial number, component release number and component performance specifications. For example, with respect to a DCM, the component performance specifications may include the component insertion expected signal loss value, the component expected dispersion value, and the dispersion versus wavelength characteristics of the component (used to build a detailed system model). Since information stored in memory 18 is static, it is desirable that memory 18 be a read only memory so that such information cannot be corrupted. Optionally, a read-write memory module 21 may be provided for storing the actual operating characteristics of the passive component(s) at various points in time. This historical performance information may be used for charting the performance of each passive component over time to predict possible future failure. Thus, where sub-system 10 has a DCM, the historical performance information will include actual insertion loss and dispersion values at various points in time.

It will be understood that the component information is typically pre-programmed into the non-volatile memory 18. With respect to a dispersion compensation module, component information such as model and release number may be easily obtained from the manufacturer and stored. For other component information, such as expected insertion loss and average chromatic dispersion values (which are both a function of wavelength for one or more wavelength ranges), the information may be obtained from direct test measurements on the actual dispersion compensation module, or via technical specification sheets supplied by the manufacturer of the dispersion compensation module. After obtaining this information, it may be stored in the EEPROM 18 along with the other component information prior to installation of sub-system 10.

After installation of sub-system 10, a power source 25 and a CPU (processor) 22 may be connected to sub-system 10 via interface 16 and agent software residing on the CPU may be used to retrieve information stored in memory 18. Retrieved component information identifies the installed passive components and their specifications. Such information may be compared against design specifications for the system incorporating sub-system 10 to verify that the correct passive components were installed.

The CPU 22 may also be associated with a tester 23 which may be connected to the interface and monitor the signal at the input and the output of the passive components. Alternatively, if the system is shut down, the tester may send a test input signal over interface 16 to the passive components and monitor the test output signal. The value of the input and output signals are sampled by the CPU 22 which may calculate performance characteristics of the passive components therefrom and compare such performance characteristics with the retrieved performance specifications for the passive components. If the actual performance of the passive components is not within acceptable tolerance, the CPU 22 may generate a warning or a suggested course of action. If the actual performance is within tolerance, the CPU may store the actual performance results in the historical performance information memory 21, along with the date for the actual performance results.

Whenever performance results, while within tolerance, are not ideal, the CPU 22 may retrieve all historical performance information in memory 21 and conduct a trend analysis. As a result of this analysis, the CPU may prompt a user as to an expected date of failure or recommend a date for re-test of the passive components.

Communication between the interface 16 and the CPU can be any of the available industry standard serial communication protocols, such as the I²C communication protocol developed by Philips Electronics Limited.

In an alternate arrangement, a microcontroller 22a and tester 23a may be incorporated into sub-system 10. The microcontroller 22a is operatively connected to memory 18, memory 21, and to tester 23a. In such instance, the microcontroller has paths to the interface 16 and the tester has a connection 27 to the passive components.

The microcontroller 22a and tester 23a operate in the same fashion as CPU 22 and tester 23 except that the microcontroller may report back to a central controller for the system via the interface 16.

From the foregoing, it will be apparent the CPU 22 and microcontroller 22a both act as processors.

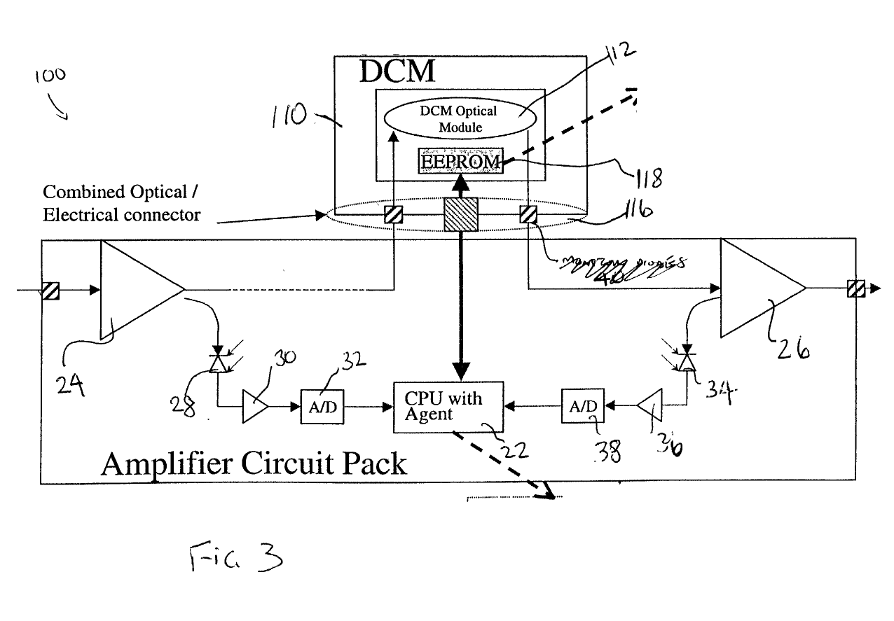

FIG. 3 illustrates a specific embodiment of the present invention and shows a system 100 comprising a sub-system 110 connected to two active circuits. In this embodiment, the sub-system 110 includes a dispersion compensation module (DCM) 112 as a passive component and an EEPROM 118 as the memory module. Sub-system 110 is connected between a first amplifier 24 (which is an active circuit) and a second amplifier 26 (another active circuit) via interface 116. Interface 116 is also connected to a CPU 22.

A tester for the sub-system 110 comprises an optical tap coupler connected to an optical detector 28, followed by a trans-impedance amplifier 30 feeding into an analog to digital (AD) converter 32 connected between an output of amplifier 24 and an input of CPU 22 and an optical tap coupler connected to an optical connector 34, followed by a trans-impedance amplifier 36, and AD converter 38 connected between an output of amplifier 26 and an input of CPU 22.

During operation, the inputs to CPU 22 from AD 32 and AD 38 allow the CPU to calculate the actual power insertion loss of the DCM, between amplifiers 24 and 26. The CPU can also read from EEPROM 118 the specifications for dispersion and insertion loss for the DCM 112. If the calculated insertion (power) loss exceeds the specifications for the loss which should result from insertion of the DCM by more than a threshold, a warning is issued by the CPU 22. This warning may simply be a prompt to clean the surfaces of interface 116. If the calibrated dispersion data from the EEPROM is not in the desired range of dispersion compensation (as determined by link engineering rules or provisioning requirements for the DCM), the CPU 22 may issue a warning calling for replacement of the sub-system 110.

In the embodiment of FIG. 3, typically the CPU 22 would be a permanent part of system 100. In such case, optionally static component information, such as model number and manufacturer name, may be stored in memory located within the CPU 22 so that the CPU 22 does not have to continuously request and retrieve the static component information since the component information does not change during operation of the subsystem 10.

The CPU could report back warnings over a network to a central location. In other embodiments, the CPU may be removable and used by a user in monitoring various sub-systems in a system.

It will be understood that the interface 16 may alternatively be a backplane connector or a combined optical/electrical external connector. It will also be appreciated that a sub-system may have a number of passive components, with one (or, optionally, more than one) associated identification module.

Optionally, the memory in the identification module may only store a sub-set of component information, such component identification information for the passive component(s) or component identification information and specifications for the passive component(s).

The above-described embodiments are intended to be illustrative only, and in no way limiting. The embodiments are susceptible to many modifications of form, size, arrangement of parts and details and order of operation. The invention, rather, is intended to encompass all such modifications within its scope as defined by the claims.

What is claimed is:

1. At sub-system comprising:
at least one passive component; and
an identification module for storing component information relating to said at least one passive component.

2. The sub-system of claim 1 wherein said component information comprises component identification information, component specifications, and component calibration data.

3. The sub-system of claim 1 further comprising a common interface for said at least one passive component and said identification module.

4. The sub-system of claim 3 wherein said interface comprises optical or electrical terminals for said at least one passive component and electrical terminals for said identification module.

5. The sub-system of claim 1 wherein said identification module comprises a non-volatile memory.

6. The sub-system of claim 5 further comprising:
a tester interconnected with said at least one passive component; and
a processor interconnected with said memory and with said tester.

7. The sub-system of claim 5 wherein said non-volatile memory comprises a read-only memory.

8. The sub-system of claim 7 wherein said identification further comprises a second memory, said second memory being a read-write memory.

9. The sub-system of claim 8 wherein said second memory stores historical performance information relating to said at least one passive component.

10. Apparatus for monitoring a passive component, comprising:
a non-volatile memory storing specifications for a passive component;
a tester for detecting signals at an input and output of said passive component; and
a. processor operatively associated with said non-volatile memory and said tester for monitoring proper performance of said passive component.

11. A method for facilitating monitoring of a passive component, comprising:
storing component information for said passive component in a non-volatile memory; and
installing said non-volatile memory in a sub-system incorporating said passive component.

12. The method of claim 11 further comprising configuring a common interface for said passive component and said non-volatile memory.

13. A method for monitoring a passive component, comprising:
retrieving specification information for said passive component from non-volatile memory installed in a sub-system incorporating said passive component;
sampling an input signal to and an output signal from said passive component;
determining performance characteristics for said passive component based on said sampling;
comparing said performance characteristics with said retrieved specification information.

14. The method of claim 13 further comprising, based on said comparing, selectively generating a warning.
